(19) United States
(12) Patent Application Publication
(10) Pub. No.: US 2017/0026860 A1
(43) Pub. Date: Jan. 26, 2017

(54) DEVICE AND METHOD FOR DETECTING HIGH WIND WEATHER EVENTS USING RADIO EMISSIONS

(71) Applicant: Carrier Corporation, Farmington, CT (US)

(72) Inventors: Christopher Coy Fuller, Bloomington, MN (US); Rene Christian, Brookfield, WI (US)

(21) Appl. No.: 15/200,717

(22) Filed: Jul. 1, 2016

Related U.S. Application Data
(60) Provisional application No. 62/188,034, filed on Jul. 2, 2015.

(51) Int. Cl. H04W 24/08; H04W 72/04; H04W 4/22

(52) U.S. Cl. CPC H04W 24/08; H04W 4/22; H04W 72/0453

(57) ABSTRACT

A device and method for detecting a high wind weather event by receiving at least one radio emission over one or more channels, estimating an environment emission from the at least one radio emission, comparing the reference emission and the environment emission to obtain at least one pattern of interest, and identifying a high wind weather event based at least in part on the at least one pattern of interest.

### CROSS REFERENCE TO RELATED APPLICATIONS

The present application is related to, and claims the priority benefit of, U.S. Provisional Patent Application Ser. No. 62/188,034 filed Jul. 2, 2015, the contents of which are hereby incorporated in their entirety into the present disclosure.

### TECHNICAL FIELD OF THE DISCLOSED EMBODIMENTS

The presently disclosed embodiments are generally related to weather detection devices; and more particularly to a device and method for detecting high wind weather events using radio emissions.

### BACKGROUND OF THE DISCLOSED EMBODIMENTS

Generally, weather radars often look higher in the atmosphere than where most of the tornadic activity occurs, and from where ground level effects of high wind events occur. Even when a tornado is detected, many communities do not have effective weather alert systems in place. Furthermore, many people live outside the range of such systems and in some instances, the systems have malfunctioned.

Accordingly, there exists a need for a device and method to more reliably detect high wind weather events at a more localized, and lower level.

### SUMMARY OF THE DISCLOSED EMBODIMENTS

In one aspect, a device for determining the occurrence of a high wind weather event is provided. The device includes a processor, a memory, and a communication device in communication with one another. One or more programs are stored in memory and are configured to be executed by the processor. The programs are configured to determine an occurrence of a high wind weather event.

In an embodiment, the device may include a security panel for a home or office building. In other embodiments, the device may include other devices such as a thermostat, a home automation panel, an elevator controller, an aircraft control panel, cellular phone base station, an automobile, a mobile phone, tablet or any device configured to be carried outside a home to name a few non-limiting examples.

The communication device includes one or more channels to receive at least one radio emission. In an embodiment, the one or more channels operate in a frequency band less than or equal to approximately 100 GHz. In another embodiment, the communication device may be configured to transmit a device signal.

In one aspect, a method of detecting a high wind event is provided. The method includes the step of receiving at least one radio emission over one or more channels of the communication device. In an embodiment, the at least one radio emission is chosen from a group consisting of non-cooperative and cooperative radio emissions.

The method further includes the step of estimating a reference emission from the at least one radio emission. In an embodiment, a reference emission may be demodulated in a way which suppresses the weaker emissions and extracts the stronger emissions within the received at least one radio emission in order to estimate the reference emission as transmitted by the non- cooperative transmitter antenna. In another embodiment, the at least one radio emission is filtered to remove strong nearby clutter, and strong reflections of the reference emission from undesirable targets in order to determine/estimate the reference emissions transmitted by the radio transmitters.

The method further includes the step of estimating an environment emission from the at least one radio emission. In an embodiment, an environment emission may be estimated by applying a first filter to the plurality of radio emissions received on one or more channels of the communication device.

The method further includes the step of comparing the reference emission and the environment emission to obtain at least one pattern of interest. In an embodiment, the at least one pattern of interest includes at least one of a Doppler shift, amplitude shift, and time shift. In an embodiment, the environment emissions may then be passed through a second filter to detect patterns of interest in the processed environmental emissions, and to limit the number of patterns to the number which the device may process within an available time. If a pattern of interest cannot be obtained, the method returns to the step of receiving at least one radio emission or to actively tracking the at least one high wind weather event.

The method further includes the step of identifying a high wind weather event based at least in part on the at least one pattern of interest. If a high wind weather event cannot be identified, the method returns to the step of receiving at least one radio emission or proceeds to actively tracking the at least one high wind weather event.

In an embodiment, the method further includes the step of confirming the identified high wind weather event. In another embodiment to confirm the identified high wind weather event, the device may monitor one or more channels including frequencies which have been determined to manifest characteristic emissions within the 0.1 MHz to 100 MHz frequency bands, and determine whether an electromagnetic emission characteristic of the environment has occurred. In another embodiment, measuring a time-frequency characteristics of lightning strike electromagnetic emissions may be used to confirm the identified high wind weather event. Moreover, secondary confirmation may come from another device or system in communication with the device.

In one embodiment, the method further includes the step of tracking the confirmed high wind weather event. In an embodiment, the method further includes the step of determining a threat level of the high wind weather event. The method further includes the step of transmitting an alert signal based at least in part on the threat level. In one embodiment, the threat level is based at least in part on a high wind weather event threat level and a system-wide threat level. In an embodiment, the alert signal comprises at least one of an audio signal and a visual signal.

### BRIEF DESCRIPTION OF DRAWINGS

FIG. 1 illustrates a schematic diagram of a high wind event weather detection system according to an embodiment of the present disclosure;

FIG. 2 illustrates a schematic flow diagram of a method for detecting a high wind weather according to one embodiment of the present disclosure; and

FIG. 3 illustrates a schematic diagram of a high wind event weather detection system according to an embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

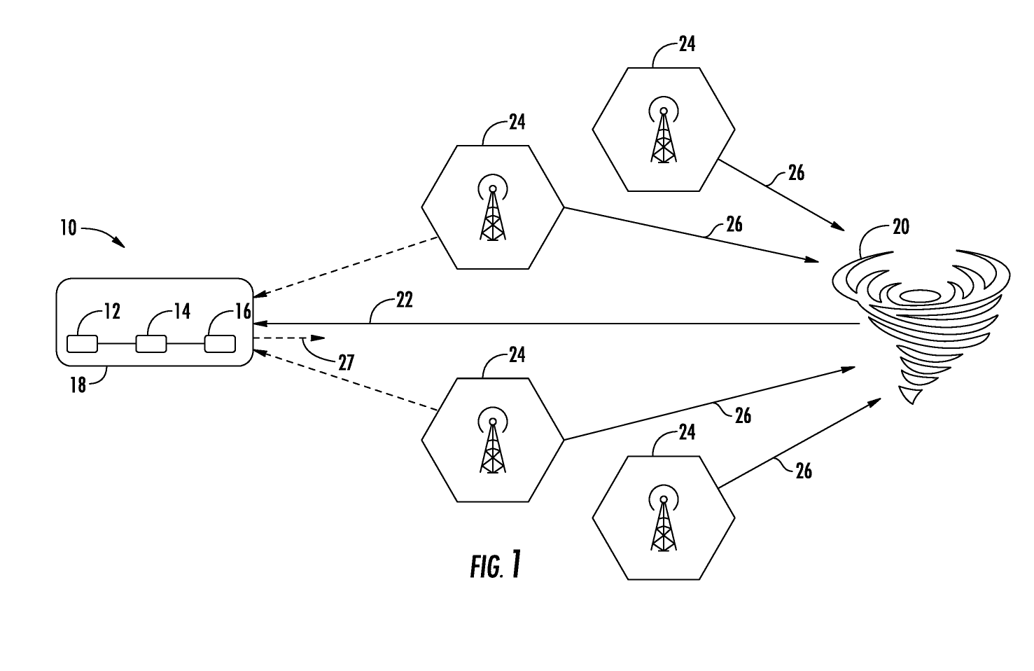

FIG. 1 illustrates a device for determining the occurrence of a high wind weather event, generally indicated at 10. The device 10 includes a processor 12, a memory 14, and a communication device 16 in communication with one another. It will be appreciated that the processor 12, memory 14, and communication device 16 may be disposed in a housing 18 or part of a separate console to name a couple of non-limiting examples. One or more programs are stored in memory 14 and are configured to be executed by the processor 12. The programs are configured to determine an occurrence of a high wind weather event 20, for example a tornado or a wind storm to name a couple of non-limiting examples according to the method described herein.

In an embodiment, the device 10 may include a security panel for a home or office building. In other embodiments, the device 10 may include other devices such as a thermostat, a home automation panel, an elevator controller, an aircraft control panel, cellular phone base station, automobile, GPS receiver, a mobile phone, tablet or any device configured to be carried outside a home to name a few non-limiting examples.

The communication device 16 includes one or more channels to receive at least one radio emission 22. In an embodiment, the one or more channels operate in a frequency band less than or equal to approximately 100 GHz. It will be appreciated that the one or more channels may operate at a frequency band greater than 100 GHz. For example, the communication device 16 may operate at a frequency between approximately 70 MHz to 6 GHz.

In another embodiment, the communication device 16 may be configured to transmit a device signal 27. For example, in the U.S., the communication device 16 may transmit a device signal at approximately 40 decibels below the unintentional emission limit established by the Federal Communications Commission in bands for which the communication device 16 would not otherwise be authorized to operate. Transmission may occur at frequency bands where non-cooperative transmitters 24 may not be found and possibly in bands where non-cooperative transmitters are detected. In such situations, the device 10 may transmit a cooperative or non-cooperative radio signal for the detection of surroundings including high wind weather events 20. The range of the transmitted device signal may be limited, but the received emissions may be used for a variety of benefits, including but not limited to, increased knowledge of local clutter for improving the estimates of desired signal, and detection of high wind weather events by measuring the characteristics of local clutter.

It will be appreciated that by using multiple antennas to detect incoming environment emissions, the direction to the high wind event 20, location, rate of ground motion, intensity of the high wind event, estimated time to impact, and other features may be determined. Furthermore, by using multiple antennas for the transmitter, receiver or both, the relative Doppler shift of each measurement will vary based on the distance and angle of the antennas versus the high wind event, enabling high resolution processing based on synthetic aperture and related techniques. Someone familiar with the state-of-the-art of antenna arrays will realize that the multiple antennas may be arrayed in a variety of ways which may include beam-forming, monopulse configuration, linear arrays, circular arrays, ellipsoidal arrays, phased arrays and other types made from a wide assortment of antenna types including monopole, log-periodic, horn, patch antennas and other types.

The use of multiple antennas may all be part of one detection system or may be from multiple systems which share data on the detections. It will be appreciated that a single receiving antenna, listening to multiple transmitters, would be able to perform the functions as described herein. It will further be appreciated that processing of environment emissions may occur on an individual system measuring the environment emissions or processing may occur in a central computing system (e.g. multiple coordinated individual systems).

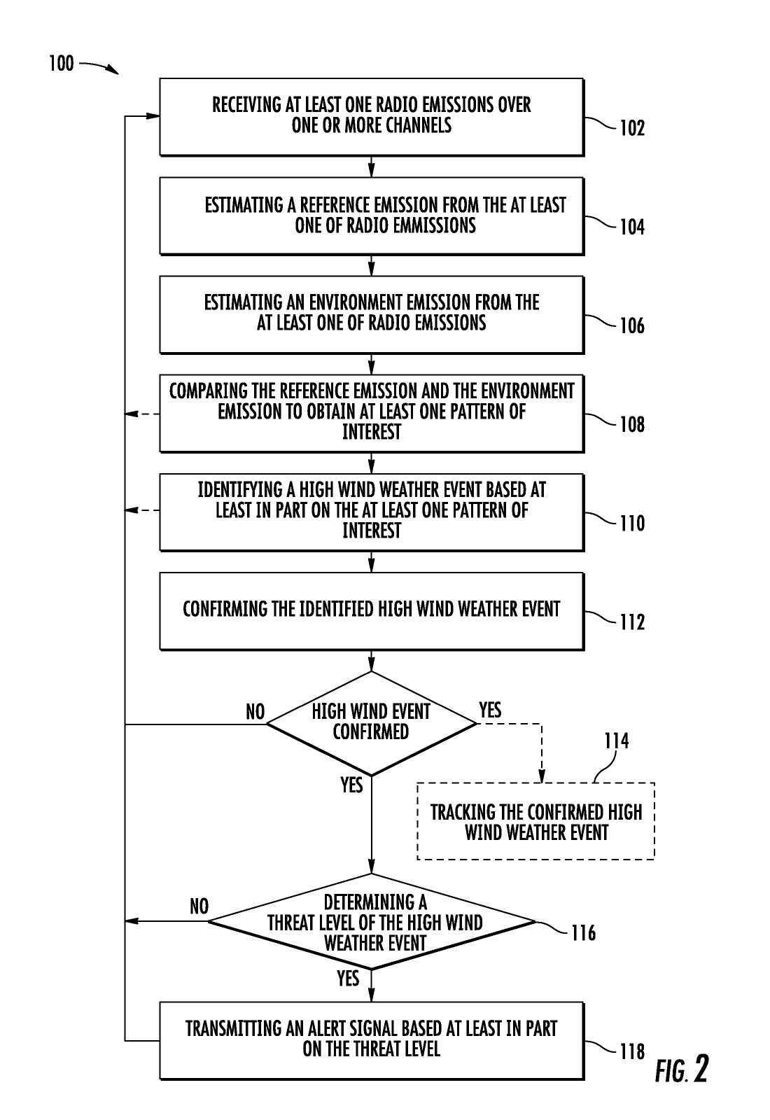

FIG. 2 illustrates a method of detecting a high wind event 20 utilizing the device 10, the method generally indicated at 100. In an embodiment, the method includes step 102 of receiving at least one radio emission 22 over one or more channels of the communication device 16. In an embodiment, the at least one radio emission 22 is chosen from a group consisting of non-cooperative and cooperative radio emissions.

For example, with reference to FIG. 1, one or more of the non-cooperative transmitters 24 emits a transmitter emission 26. It will be appreciated that the non-cooperative radio transmitters 24 used for the present embodiments include, but are not limited to, a cellular network, AM radio, FM radio, television, and two-way transmitters to name a few non-limiting examples.

If a high wind weather event 20 is present, the transmitter emission 26 and/or 27 is reflected from the environment (e.g. debris, vegetation, rain, or other objects) which are affected by the high wind weather event 20. The device 10 may continuously or intermittently monitor the one or more channels of the communication device 16 by sweeping or hopping frequency channels over multiple frequency bands to receive at least one radio emission 22 reflected by the environment. The frequency sweeping system would sweep across a wide range of frequency which may or may not overlap. Each frequency channel which does not overlap will require use of a new reference signal which reflects from the environment. The bandwidth of each channel in a normal implementation would be the same for each channel, but in some implementations, in order to detect a useful reference signal, it may be necessary to widen the bandwidth of the channel or overlap the channels, requiring channel bandwidths which change over time.

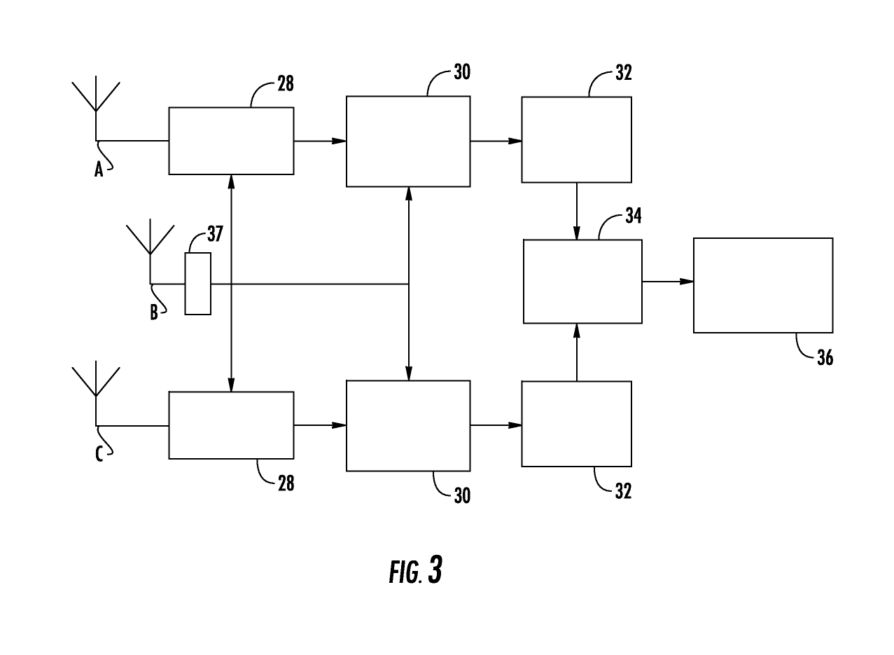

The method further includes step 104 of estimating a reference emission from the at least one radio emission 22, as shown by process block 37 in FIG. 3. In an embodiment, a reference emission may be demodulated in a way which suppresses the weaker emissions and extracts the stronger emissions within the received at least one radio emission 22 in order to estimate the reference emission as transmitted by the non-cooperative transmitter antenna 24.

It will be appreciated that a reference emission may include any estimate of a signal transmitted by a non-cooperative transmitter as received by the device 10. This emission may include a direct path signal which has not been reflected or possibly Doppler shifted between a transmitter and a receiver, although sometimes reflections of the reference emission from the environment are unavoidable. The reference emission may be a largest amplitude signal being received in the band being used and all remaining signal content after the reference emission is subtracted or removed from the at least one radio emission 22 would primarily consist of reflections of the reference emission from the environment, although it is usually not possible to eliminate the reference emission perfectly from the radio emissions.

For example, the device 10 may estimate reference emissions at a GSM cell tower 24 via a prior knowledge of standard Dummy Burst (DB) transmissions for which signals received without Doppler shift are assumed to be part of the reference emission Similar techniques may be used in other bands where specific transmissions are known to occur and may be identified. The zero Doppler method (e.g. CLEAN), which attenuates all frequency components around zero Doppler signals received, may be combined with or alternated with other methods, for example, a method, which also include consideration of time of arrival and amplitude (e.g. Direct Path Cancellation, DPC) to estimate the reference emission.

In another embodiment, the at least one radio emission 22 is filtered to remove strong nearby clutter, and strong reflections of the reference emission from undesirable targets (e.g. buildings) in order to estimate the reference emissions transmitted by the radio transmitters 24. It will be appreciated that the device 10 may use multiple methods to demodulate the at least one radio emission 22, including but not limited to, narrowband receivers, wideband receivers, direct down conversion from an antenna (not shown), super-heterodyne, direct comparison to a re-creation of the transmit signal 26 via a software defined radio, and other methods with fixed or variable integration periods.

The method 100 further includes step 106 of estimating an environment emission from the at least one radio emission 22. It will be appreciated that an environment emission may include radio emission signals in which the estimated reference emission signal has been subtracted in a way to minimize the strongest amplitude of the reference emission leaving, predominantly signal components which represent reflections from the environment of the reference emissions. Complex schemes for generating the environment emission may also reduce the amplitude of the reference emission which has been strongly reflected by clutter in the environment.

Generally, the reference emission is more powerful than the environment emission; thus, it is important that the reference emission and large reflections from the environment are removed from the at least one radio emission 22. In an embodiment, as shown in FIG. 3, an environment emission may be estimated by applying a first filter 28 to the plurality of radio emissions 22 received on the one or more channels (A-C) of the communication device 16.

For example, the device 10 operates to attenuate the reference emission, such that the remaining environment emissions primarily represent reflections from the environment including environment emissions that are representative of high wind weather events 20. It will be appreciated that the device 10 may use multiple methods to attenuate the reference emission, and possible attenuate strong clutter and noise shown by process block 28 in FIG. 3, including in full, in part, or in combinations of Gradient Adaptive Lattice algorithm, Normalized Least Mean Squares, Standard Least Mean Squares, Range-Doppler, Space Time Adaptive Processing, Bayesian Compressive Sensing, Constant Modulus Algorithm, CLEAN algorithm, Iterative Adaptive Approach for Amplitude and Phase Estimation algorithm, Generalized Estimation of Multipath signal, pre-detection of reference signal, Generalized Notch Filter, and Extensive Cancellation Algorithm to name a few non-limiting examples.

The method 100 further includes step 108 of comparing the reference emission and the environment emission to obtain at least one pattern of interest. In an embodiment, the at least one pattern of interest includes at least one of a Doppler shift, amplitude shift, and time shift. It is noted that the Doppler shift, amplitude shift, and time shift are often equally important when detecting high wind weather events (e.g. tornadoes); though in some circumstances one parameter may be more important. It will be appreciated that a pattern of interest may be select portions of the environmental emission signal of which a signal or set of signals which may be indicative of a high wind weather event, but which further processing is required to determine with certainty. By ignoring signals within the environmental emissions which are not considered part of a pattern of interest, the system is able to more efficiently process signals and apply more processing power to the signals which are more likely to be part of a high wind weather event. If a pattern of interest cannot be obtained, the method returns to step 102 to receive at least one radio emission or step 114 if the tracking sub-system is actively tracking at least one high wind weather event.

Continuing with the example in FIG. 3, once the reference emission is estimated (block 37) and removed from the at least one radio emission 22 (block 28), the environment emissions are processed at block 30 to generate a plurality of relative time, amplitude and Doppler shift signals with respect to the reference emission. It will be appreciated that the device 10 may generate the plurality of time, amplitude, and Doppler signals by such techniques as decimation and integration/filtering, cross-correlation, direct comparison to the reference signal in a time-domain and/or frequency domain, inter-receiver processing, General Likelihood Ratio Test, and Bayesian General Likelihood Ratio Test, or any combination thereof, to name a few non-limiting examples. It will further be appreciated that the device 10 may further process the environment emissions to generate images, or organize the data in other ways to improve the probability of detecting a high wind weather event and/or simplify detections of pattern of interest by such other methods including but not limited to phase-interferometry, 2D-FFT, back-propagation imaging, Synthetic Aperture Radar (SAR), Synthetic Aperture Radar (SAR) Imaging, Inverse Synthetic Aperture Radar, Edge Synthetic Aperture Radar, Tomography, Maximum Likelihood Estimation, Least Mean Square Error, change detection schemes, and other techniques in combination or individually.

In an embodiment, the environment emissions may then be passed through a second filter 32 to detect patterns of interest in the processed environmental emissions, and to limit the number of patterns to the number which the device 10 may process within an available time. It will also be appreciated that the second filter 32 may determine the range, directional angle, reflectivity and/or Doppler shift of each portion of each pattern-of-interest, which may include high wind weather events 20, and the methods of filtering may vary based on the state of the system. It will also be appreciated that the device 10 may use a variety of detection methods, including but not limited to, squelch, Constant False Alarm Rate (CFAR), blob detection, windowing, and other techniques in combination or individually for generating and disposition of patterns of interest.

The method 100 further includes the step 110 of identifying a high wind weather event 20 based at least in part on the at least one pattern of interest. For example, the imposed Doppler shift will vary based on the radial speeds of the objects within a debris ball generated by a tornado, but will oftentimes vary from hundreds of meters per second down to very low speeds. By detecting a plurality of Doppler shifts which include relatively high Doppler shifts that both approach (shift positive) and recede (shift negative), a tornado may be detected. The Doppler shift of the emissions will vary from a minimum Doppler shift to a high Doppler shift. If a high wind weather event cannot be identified, the method returns to step 102 to receive at least one radio emission or step 114 if the tracking system is actively tracking at least one high wind weather event.

Detection of relatively high Doppler shift in one direction (increasing or decreasing) or increasing and decreasing Doppler shifts with both the shifts located near the antenna may be indicative of a high wind event and/or the intensity of a high wind event. The intensity of the environment emissions reflected from the high wind event 20 may also be used to indicate relative distance to the high wind event 20 and/or intensity of the high wind event 20.

For example, the device 10 is able to distinguish between a tornado and other airborne objects such as an airplane or helicopter propeller to name a couple of non-limiting examples, because propellers cause a narrow, fixed Doppler shifts (approaching and receding) in the reflected signal whereas the debris ball from a tornado causes a wide range of Doppler shifts. Additionally, aircraft occupy a relatively small region of space compared to the debris ball from a destructive tornado. Moreover, aircraft often do not operate during severe storms, emit electromagnetic fields characteristic of tornadoes and lightning, and generally do not often cause widespread violent movement of ground vegetation. Geolocation techniques may be used to exclude area where a plurality of propellers might cause false identification of a high wind weather event near an airport or wind farm to name a couple of non-limiting examples. Other methods include, but are not limited to, pattern recognition, comparison to Bayesian statistical models, comparisons to vector models, etc.

In an embodiment, the method 100 further includes step 112 of confirming the identified high wind weather event 20. The high wind weather event 20 is confirmed via receiving information from a secondary source. When a high wind event 20 is detected, verification of conditions in which such an event may occur may be performed via any of the following: independent measurement of temperature, humidity and atmospheric pressure, automatic communication with a secondary source such as a weather bureau or commercial service via a separate device such as a cell phone, internet, Plain Old Telephone System (POTS), radio network, or via another passive radar system connected via a mesh network to name a few non-limiting examples, and communicated to the device 10. It will also be appreciated that the device 10 may include one or more sensors capable of measuring temperature, humidity and/or atmospheric pressure or devices for communicating with secondary sources of information in order to confirm the identified high wind weather event 20.

In another embodiment to confirm the identified high wind weather event 20, the device 10 may monitor one or more channels including frequencies which have been determined to manifest characteristic emissions within the 0.1 MHz to 100 MHz frequency bands, and determine whether an electromagnetic emission characteristic of the high wind weather event has occurred and to characterize the high wind weather event. By maintaining a rolling average of power versus frequency within this frequency band, or average power in the entire frequency band, a change in measured power from the average power could be used as a secondary confirmation of a high wind weather event 20.

In another embodiment, measuring a time-frequency characteristics of lightning strike electromagnetic emissions may be used to confirm the identified high wind weather event 20. A typical lightning bolt has a rise time of approximately 10 microseconds and a fall time constant of approximately 500 micro-seconds. The device 10 may monitor the frequency content of relevant bands over time combined with the described passive radar techniques to identify and determine the location of the lightening. Moreover, secondary confirmation may come from another device or system in communication with the device 10.

In one embodiment, the method 100 further includes step 114 of tracking the confirmed high wind weather event 20. Once the high wind weather event 20 is confirmed, the processor 14 will determine whether the newly identified high wind weather event 20 matches any previously detected high wind weather events. If not, the device 10 will establish a new entry in a tracking sub-system. As new detections occur, the device 10 will attempt to associate the newly identified high wind weather event 20 with previously detected high wind weather events stored in the tracking sub-system. If the tracking system sub-system is full, the system may be implemented to give priority to the tracks which appear to be the greatest threat and delete or combine detections which appear to be a lower priority. The tracking sub-system may also work in coordination with other systems to improve the detections and tracking. For example, other nearby systems may share detections and tracks in order to increase the number of entries in the tracking table, improving the statistics of predictions of the future state of a track. In another example, combining detections from multiple systems improves the range resolution, Doppler shift, ground speed, angle accuracy and other parameters by providing multiple ‘views’ of the target from multiple perspectives and increasing the effective bandwidth of the detections.

It will be appreciated that the device 10 may use such tracking methods such as use of covariance matrices, Kalman filters, extended Kalman filters, Gaussian Mixture Probability Hypothesis Density Filer, multi-stage tracking (e.g. bistatic range/Doppler and Cartesian trackers), Probabilistic Multi-Hypothesis tracker, spherical interpolation, spherical intersection, extended cross-ambiguity functions, change detection schemes, multiple stage tracking for use when integration periods for Doppler and range differ and other techniques in combination or individually as part of the tracking scheme for identified high wind weather events 20. It should be noted that the tracking sub-system will be maintained in order to remove tracked high wind weather events for which no high wind weather event 20 has been associated for a significant period of time, predict the future state (e.g. location, ground speed, direction, etc.) of all tracked high wind weather events, combine tracks of high wind weather events which are significantly close and perform other standard tracking functions.

The method 100 further includes step 116 of determining a threat level of the high wind weather event 20. For example, based on the tracking information stored about the each high wind weather event, the device 10 may determine a threat level of each track. A threshold alarm state may be set individually for one or more state parameters (e.g. EM emissions, location, estimated time of impact, direction, etc.) being tracked or a subset of state parameters being tracked.

The method 100 further includes step 118 of transmitting an alert signal based at least in part on the threat level. In one embodiment, the threat level is based at least in part on a high wind weather event threat level and a system-wide threat level which is based on the high wind weather event threat level combined with the information available from other sensors and systems. In an embodiment, the alert signal comprises at least one of an audio signal, a visual signal, and an electronic signal.

For example, the threat levels, alarm states, and/or associated track information may be used to communicate alarm conditions to users, nearby systems, central monitoring systems, government, or commercial services via the internet, phone lines, cell phone network, audible alarms, visual warnings, and/or other communication methods. It will be appreciated that the system may use high wind weather event threat levels, alarm conditions, and secondary verifications from other systems (e.g. EM emission measurements, active government radar, high wind weather event states from nearby passive radars, etc.) as part of the decision-making process to determine an overall system-wide threat levels used to determine whether to alert local users and/or other individuals and organizations of alarm conditions, high wind weather event and system threat levels, associated tracking information, or other information.

It will therefore be appreciated that the present embodiments include a device 10 configured to determine the occurrence of a high wind weather event 20 by comparing the reference emission and the environment emission to obtain at least one pattern of interest, and identifying a high wind weather event 20 based at least in part on matching the pattern of interest to the at least one environment characteristic of a high wind weather event 20. Secondary methods of verifying the presence of a high wind weather event 20 may be used to increase the confidence of the presence of a high wind weather event 20. The system may also include a tracking sub-system to aid in detecting, monitoring and making predictions about the at least one high wind weather event 20. The system may also include a sub-system for generating alerts/alarms, and communicating with other systems for the purposes of secondary verifications, alert/alarm notification and other purposes.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A device for determining an occurrence of a high wind weather event comprising:
a communication device including one or more channels configured to receive at least one radio emission;
a processor and a memory in communication with the communication device; and
one or more programs stored in memory and configured to be executed by the processor, wherein said programs are configured to:
(a) estimate an environment emission from the at least one radio emission;
(b) compare the reference emission and the environment emission to obtain at least one pattern of interest; and
(c) identify a high wind weather event based at least in part on the at least one pattern of interest.

2. The device of claim 1, wherein the programs are further configured in step (a) to estimate a reference emission from the at least one radio emission.

3. The device of claim 1, wherein the programs are further configured to:
(d) confirm the identified high wind weather event; and
(e) track the confirmed high wind weather event.

4. The device of claim 1, wherein the programs are further configured to:
(f) determine a threat level of the high wind weather event; and
(g) transmit an alert signal based at least in part on the threat level.

5. The device of claim 1, wherein the at least one radio emission is chosen from a group consisting of: non-cooperative and cooperative.

6. The device of claim 1, wherein the one or more channels operate in a frequency band less than or equal to approximately 100 GHz.

7. The device of claim 1, wherein the at least one pattern of interest comprises at least one of a Doppler shift, amplitude shift, and time shift.

8. The device of claim 3, wherein step (h) is based at least in part on a high wind weather event threat level and a system-wide threat level.

9. The device of claim 1, wherein the at least one radio emission comprises at least one device signal transmitted by the device.

10. The device of claim 4, wherein the alert signal comprises at least one of an audio signal, a visual signal, and an electronic signal.

11. A method of detecting a high wind weather event with a device in communication with one or more radio transmitters, the method comprising the steps:
(a) estimating an environment emission from the at least one radio emission;
(b) comparing the reference emission and the environment emission to obtain at least one pattern of interest; and
(c) identifying a high wind weather event based at least in part on the at least one pattern of interest.

12. The method of claim 11, wherein step (a) further comprises receiving at least one radio emission over one or more channels.

13. The method of claim 12, wherein step (a) further comprises estimating a reference emission from the at least one radio emission.

14. The method of claim 11, further comprising the steps:
(d) confirming the identified high wind weather event; and
(e) tracking the confirmed high wind weather event.

15. The method of claim 11, further comprising the steps:
(f) determining a threat level of the high wind weather event; and
(g) transmitting an alert signal based at least in part on the threat level.

16. The method of claim 11, wherein the one of more channels include a frequency band less than or equal to approximately 100 GHz.

17. The method of claim 11, wherein step (c) comprises creating a synthetic aperture radar image of the high wind weather event.

18. The method of claim 11, wherein the at least one pattern of interest comprises at least one of a Doppler shift, amplitude shift, and time shift.

19. The method of claim 14, wherein step (d) comprises receiving information from a secondary source.

20. The method of claim 14, wherein step (d) comprises:
(i) monitoring one or more channels with a frequency less than approximately 100 MHz; and
(ii) determining whether a change in an electrical characteristic of the environment has occurred.

21. The method of claim 14, wherein step (d) comprises identifying and measuring a time-frequency characteristic of a lightning strike.

22. The method of claim 15, wherein the alert signal comprises at least one of an audio signal, a visual signal, and an electronic signal.

23. The method of claim 15, wherein step (g) is based at least in part on a high wind weather event threat level and a system-wide threat level.

24. The method of claim 11, wherein step (a) further comprises transmitting at least one radio emission.
